(19) United States
(12) Patent Application Publication
(10) Pub. No.: US 2019/0143798 A1
(43) Pub. Date: May 16, 2019

(54) SEALING PROFILE FOR SEALING A PANEL ELEMENT IN A STRUCTURE, IN PARTICULAR FOR SEALING A PANE IN A MOTOR VEHICLE BODYWORK

(71) Applicant: Henniges Automotive GmbH & Co. KG, Rehburg-Loccum (DE)

(72) Inventors: Stanislav ZAK, Mladá Boleslav (CZ); Daniel SLAVIK, Bela pod Bezdezem (CZ)

(21) Appl. No.: 16/190,868

(22) Filed: Nov. 14, 2018

(30) Foreign Application Priority Data
Nov. 14, 2017 (DE) 102017126725.5

(51) Int. Cl. B60J 10/18; B60J 10/76; B60J 10/33

(52) U.S. Cl. CPC B60J 10/18; B60J 10/33; B60J 10/76

(57) ABSTRACT

In a sealing profile for sealing a panel element in a structure, in particular for sealing a pane in a motor vehicle bodywork, comprising an attachment region for attachment to the structure, wherein the attachment region has a reinforcement profile with at least one decorative region openly visible to the exterior, and at least one sealing region, provision is made such that the reinforcement profile is constituted by a thin metal material and at least one rigid plastic material, wherein the plastic material is extruded onto the metal material and wherein the metal material comprises the decorative region.

### BACKGROUND OF THE INVENTION

### Field of the Invention

The invention relates to a sealing profile for sealing a panel element in a structure, in particular for sealing a pane in a motor vehicle bodywork, comprising an attachment region for attachment to the structure, wherein the attachment region has a reinforcement profile with at least one decorative region openly visible to the exterior, and comprising at least one sealing region.

### Description of Related Art

Sealing profiles of the type mentioned at the outset are used for bordering motor vehicle panes. They bridge the gap between the glass pane and the motor vehicle bodywork, in particular between the glass pane and a flange of the bodywork. The attachment region of the sealing profile is used to attach the sealing profile to the motor vehicle bodywork, for example the sealing profile is fitted onto a bodywork flange. A sealing region can then be applied in a sealing manner to a glass pane installed fixed or movable.

Such a sealing profile with a reinforcement profile arranged in the attachment region is known from EP 1 386 769 A2. This reinforcement profile stabilises the sealing profile, and at the same time comprises a decorative region with a portion openly visible to the exterior.

The sealing region still present beside the reinforcement profile is produced from a non-rigid plastic in EP 1 386 769 A2. The sealing region extends up to the reinforcement profile; on account of the sealing properties, it is formed from the non-rigid plastic. The reinforcement profile, in contrast, has a stronger embodiment, since it takes up the retaining forces for the sealing profile.

### BRIEF SUMMARY OF THE INVENTION

The problem underlying the invention is to provide a sealing profile of the type mentioned at the outset, which is constituted lighter and simpler and, whilst having good stability, comprises a decorative region.

According to the invention, this problem is solved by the fact that the reinforcement profile is constituted by a thin metal material and at least one rigid plastic material, wherein the plastic material is extruded onto the metal material and wherein the metal material comprises the decorative region.

The sealing profile according to the invention also has a reinforcement profile. According to the invention, however, the latter comprises a thin metal material, from which it follows that the use of metal is reduced. Savings can thus be made on costs. The effect of a decorative strip or suchlike can nonetheless be created with the thin metal material on a decorative region openly visible from the exterior.

To produce the necessary stability of the sealing profile and the accompanying secure fixing of the sealing profile to the flange of, for example, a vehicle bodywork, an extruded-on rigid plastic material is provided according to the invention. The latter is extruded onto the thin metal material, so that it enters into a firm connection with the metal material and stabilises the latter after it has set to form a rigid plastic material. The thin metal material and the rigid plastic material jointly form the reinforcement profile.

According to a first development of the invention, provision is made such that the metal material is a thin sheet with a thickness of approximately 0.2 to 0.4 mm. The thin sheet thus has a thin thickness, which produces an almost foil-like embodiment.

The metal material preferably has a U-shape, wherein an outer side of a U-leg is constituted as the decorative region and the extruded-on rigid plastic material is applied at the inner sides of a the U-base and U-legs. The U-shape of the reinforcement profile is known. Such a U-profile can be fitted onto the flange of, for example, a motor vehicle bodywork. According to this development, the extruded-on plastic material is arranged at in the inner sides of the U-base and U-legs, so that the outer side of the reinforcement profile can be used as a decorative region.

The extruded-on plastic material is for example polypropylene (PP) or another rigid plastic, such as for example ABS.

A next development of the invention is characterised in that a non-rigid plastic material for forming the sealing region is extruded onto the reinforcement profile and onto the extruded-on rigid plastic material. The sealing region is formed by the non-rigid plastic material, which comprises sections which can be applied on assigned components. The rigid plastic material and the non-rigid plastic material can be extruded shortly after one another on the thin metal material forming the starting point. The production of the sealing profile can thus be automated and simplified.

With the non-rigid plastic material, corresponding sealing lips and sealing protrusions can be arranged both at the outer side of the reinforcement profile and at the inner side of the reinforcement profile.

The decorative region of the metal material openly visible to the exterior can also be coated with the extruded-on non-rigid plastic material. This coating serves to protect the decorative region during a production phase. Once this has been completed, the coating of the decorative region can be removed.

For the further embodiment of the invention, provision is also made such that a primer is applied on sections of the metal material and of the rigid plastic material before the extruding-on of the non-rigid plastic material. This primer improves the connection between the metal material and the rigid plastic material on the one hand and the non-rigid plastic material on the other hand. The primer is not therefore applied to the regions of the metal material which subsequently form the decorative region visible to the exterior.

The non-rigid plastic material is preferably an EPDM.

### BRIEF DESCRIPTION OF THE DRAWINGS

An example of embodiment, from which further inventive features emerge, is represented in the drawing. In the figures:

FIG. 1: shows a sealing profile according to the invention during its fitting on the flange of a motor vehicle bodywork and

FIG. 2: shows the sealing profile according to FIG. 1 during its use.

### DETAILED DESCRIPTION

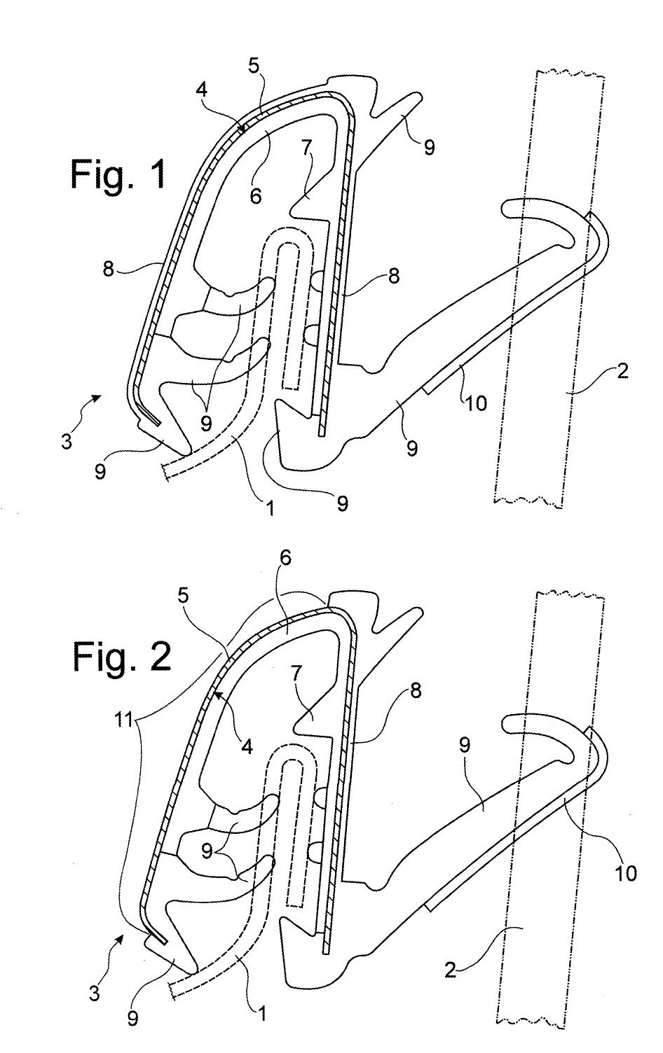

FIG. 1 shows a flange 1 of a motor vehicle bodywork, towards which a glass pane 2 is to be brought up close. The transition between flange 1 and glass pane 2 is ensured by the sealing profile according to the invention, for which purpose the latter is fixed to flange 1.

For the fastening of the sealing profile, attachment region 3 with the sealing profile is placed on flange 1. Attachment region 3 comprises a reinforcement profile 4 constituted U-shaped. According to the invention, reinforcement profile 4 is constituted by a thin metal material 5 and a rigid plastic material 6 extruded onto metal material 5. Rigid plastic material 6 is arranged at the inner sides of the U-legs and the U-base of reinforcement profile 4. Rigid plastic material 5 forms, with the aid of a protrusion 7, an end stop for the fitting of the sealing profile on bodywork flange 1.

A non-rigid plastic material 8 is arranged on the outer side of reinforcement profile 4. Said non-rigid plastic material is extruded onto metal material 5 and onto rigid plastic material 6, it covers the outer side of reinforcement profile 4 and also forms sealing lips 9. The latter are applied against various sections of bodywork flange 1 or against glass pane 2. Sealing lip 9, for its application on glass pane 2, is also coated with a flock material 10, which improves the slidability of pane 2 along non-rigid plastic material 8.

FIG. 2 shows the sealing profile with the formation of a decorative region 11 visible to the exterior. This decorative region 11 is constituted by thin metal material 5 by sections at the outer side of a U-leg of reinforcement profile 4. Non-rigid plastic material 8 is removed in this region. In other regions, non-rigid plastic material 8 adheres to thin metal material 5 or to rigid plastic material 6, preferably by using a primer between these materials.

1. A sealing profile for sealing a panel element in a structure, in particular for sealing a pane in a motor vehicle bodywork, comprising an attachment region for attachment to the structure, wherein the attachment region has a reinforcement profile with at least one decorative region openly visible to the exterior, and at least one sealing region,
wherein
the reinforcement profile is constituted by a thin metal material and at least one rigid plastic material, wherein the plastic material is extruded onto the metal material and wherein the metal material comprises the decorative region.

2. The sealing profile according to claim 1, wherein the metal material is a thin sheet with a thickness of approximately 0.2 to 0.4 mm.

3. The sealing profile according to claim 1, wherein the metal material has a U-shape, wherein an outer side of a U-leg is constituted as the decorative region and the extruded-on rigid plastic material is applied at the inner sides of a the U-base and U-legs.

4. The sealing profile according to claim 1, wherein the extruded-on rigid plastic material is PP.

5. The sealing profile according to claim 1, wherein a non-rigid plastic material for forming the sealing region is additionally extruded onto the thin metal material and onto the extruded-on rigid plastic material.

6. The sealing profile according to claim 5, wherein sealing lips are formed with the non-rigid plastic material.

7. The sealing profile according to claim 5, wherein the decorative region of the metal material openly visible to the exterior is coated with the extruded-on non-rigid plastic material.

8. The sealing profile according to claim 5, wherein a primer is applied on sections of the thin metal material and of the rigid plastic material before the extruding-on of the non-rigid plastic material.

9. The sealing profile according to claim 5, wherein the non-rigid plastic material is an EPDM.
